(19) United States
(12) Patent Application Publication
(10) Pub. No.: US 2026/0171725 A1
(43) Pub. Date: Jun. 18, 2026

(54) 2-POLE KEYED SOLAR SAFETY CONNECTOR

(71) Applicant: Panduit Corp., Tinley Park, IL (US)

(72) Inventors: Sahar Ramahi, Palos Hills, IL (US); Rodney G. Rouleau, Lake Village, IN (US); Russell K. Morrow, Tinley Park, IL (US); Steven J. Baskerville, Manhattan, IL (US); Thuc K. Vu, Plainfield, IL (US); Gabriela R. Sims, Gary, IN (US)

(73) Assignee: Panduit Corp., Tinley Park, IL (US)

(21) Appl. No.: 19/374,392

(22) Filed: Oct. 30, 2025

Related U.S. Application Data
(60) Provisional application No. 63/734,243, filed on Dec. 16, 2024.
(60) Provisional application No. 63/734,239, filed on Dec. 16, 2024.

(51) Int. Cl. H01R 13/642; H01R 13/02; H01R 13/504; H01R 13/52; H01R 13/627; H01R 103/00

(52) U.S. Cl. CPC H01R 13/642; H01R 13/025; H01R 13/504; H01R 13/5202; H01R 13/6273; H01R 2103/00

(57) ABSTRACT

A 2-pole keyed safety connector is provided that is designed to reduce the chance of incorrect connections between connectors. The safety connector is configured to achieve these safety features by utilizing uniquely shaped keyed connector pairs that enable connections between the intended designated mating pair connector.

### CROSS-REFERENCE TO RELATED APPLICATION(S)

This application claims benefit to U.S. Provisional Patent Application No. 63/734,243, filed Dec. 16, 2024, and claims benefit to U.S. Provisional Patent Application No. 63/734,239, filed Dec. 16, 2024, the entirety of all of which are hereby incorporated by reference herein.

### TECHNICAL FIELD

This application relates to a 2-pole keyed safety connector that includes mating features to ensure the safe transmission of electric power in the field of, for example, solar panel installations.

### BACKGROUND

The solar energy industry is rapidly expanding, with solar farms being developed at an increasing rate. As these farms continue to grow and develop, so does the opportunity to improve safety and efficiency in the electrical connections linking solar panels. Solar farms are designed to operate at specified voltage levels that are maintained by connecting individual solar panels 110 in series to form a “string”, as shown in FIG. 1. To form this string of solar panels 110, a first cable 120 from a first solar panel 110 is mated with a second cable 130 from a second solar panel 110. More specifically, FIG. 2A shows a magnified view of one such mating relationship where a male MC4 connector from the first cable 120 is configured to mate with a female MC4 connector from the second cable.

As further shown in FIG. 2B, the male MC4 connector 121 and the female MC4 connector 131 may be generally used throughout the solar panel system 100. For example, the string of solar panels 110 may then be connected to a home run system via a main cable 140, in which the main cable 140 conducts the electricity from the array of strings of solar panels 110 into an inverter and/or other solar panel system component for managing the generated solar power. Despite their widespread use, the current MC4 solar connectors allow for the risk of user errors to accidentally connect multiple strings of solar panels 110 improperly, which may lead to issues in the solar panel system 100.

Furthermore, a less experienced technician could unintentionally make connections that may create an output that exceeds the maximum voltage conditions and result in safety risks (i.e., electrical arcing, fires).

### SUMMARY

Disclosed herein is a 2-pole keyed safety connector (hereinafter the “safety connector”) that is designed to reduce the chance of incorrect connections. The safety connector is configured to achieve these safety features by utilizing uniquely shaped keyed connector pairs that enable connections between the intended designated mating pair connector. Then by placing these keyed connectors at the end of each string of solar panels, this ensures that both the voltage and amperage remain at safe levels and the connections made to the home run are reliable and secure, as intended by the system design.

According to some embodiments, a connector system is disclosed. The connector system comprising a first connector and a second connector. The first connector comprising a first body, a first plug positioned at a first end of the first body, the first plug including a key-up feature, a first mating feature configured into the first body, a first end post positioned at a second end of the first body, the first end post including threads, and a first end cap configured to screw onto the threads of the first end post. The second connector comprising a second body, a second plug positioned at a first end of the second body, the second plug including a key-down feature, a second mating feature protruding out the second body, wherein the second mating feature is configured to fit into the first mating feature to mate the second connector to the first connector, a second end post positioned at a second end of the second body, the second end post including threads, and a second end cap configured to screw onto the threads of the second end post.

According to some embodiments, a connector system is disclosed. The connector system comprising a first connector and a second connector. The first connector comprising a first body, a first receptacle positioned at a first end of the first body, the first receptacle including a key-up feature, a first mating feature configured into the first body, a first end post positioned at a second end of the first body, the first end post including threads, and a first end cap configured to screw onto the threads of the first end post. The second connector comprising a second body, a second receptacle positioned at a first end of the second body, the second receptacle including a key-down feature, a second mating feature protruding out the second body, wherein the second mating feature is configured to fit into the first mating feature to mate the second connector to the first connector, a second end post positioned at a second end of the second body, the second end post including threads, and a second end cap configured to screw onto the threads of the second end post.

According to some embodiments a connector system is disclosed, the connector system comprising: a plug connector comprising: a plug housing body; a plug protrusion positioned at a first end of the plug connector, the plug protrusion including a first keyed feature; a first end post positioned at a second end of the plug housing body, the first end post including threads; and a first end cap configured to screw onto the threads of the first end post; a receptacle connector comprising: a receptacle body; a receptacle opening positioned at a first end of the receptacle body, the receptacle opening including a second keyed feature configured to allow the plug protrusion to fit inside the receptacle opening; a second end post positioned at a second end of the receptacle body, the second end post including threads; and a second end cap configured to screw onto the threads of the second end post.

A detailed description of these and other non-limiting exemplary embodiments of the safety connector is set forth below together with accompanying drawings.

### BRIEF DESCRIPTION OF THE DRAWINGS

FIG. 1 shows a portion of an exemplary solar panel system using a known type of connector.

FIG. 2A shows a magnified view of mating connectors taken from a portion of the solar panel system from FIG. 1.

FIG. 2B shows a magnified view of mating connectors taken from a portion of the solar panel system from FIG. 1.

FIG. 3 is a perspective view of male safety connectors in both a first pole and second pole configuration, where the two male safety connectors may be mated to each other, according to an embodiment of the present disclosure.

FIG. 4 is a perspective view of female safety connectors in both a first pole and second pole configuration, where the two female safety connectors may be mated to each other, according to an embodiment of the present disclosure.

FIG. 5 is a perspective view of the male safety connectors shown in FIG. 3 and the female safety connectors shown in FIG. 4, according to an embodiment of the present disclosure.

FIG. 6 is a top-side view, a side view, and a bottom-side view of the male safety connector shown in FIG. 3, where the two male safety connectors are mated together, according to an embodiment of the present disclosure.

FIG. 7 is a top-side view, a side view, and a bottom-side view of the female safety connector shown in FIG. 4, where the two female safety connectors are mated together, according to an embodiment of the present disclosure.

FIG. 8A is a first perspective view of the male safety connectors shown in FIG. 3, according to an embodiment of the present disclosure.

FIG. 8B is a second perspective view of the male safety connectors shown in FIG. 3, according to an embodiment of the present disclosure.

FIG. 8C is a first perspective view of the female safety connectors shown in FIG. 4, according to an embodiment of the present disclosure.

FIG. 8D is a second perspective view of the female safety connectors shown in FIG. 4, according to an embodiment of the present disclosure.

FIG. 9 is an exploded view of the male safety connectors shown in FIG. 3, according to an embodiment of the present disclosure.

FIG. 10 is an exploded view of the male safety connectors shown in FIG. 3, where conductor wires are shown installed into the male safety connectors, according to an embodiment of the present disclosure.

FIG. 11 is an exploded view of the female safety connectors shown in FIG. 4, according to an embodiment of the present disclosure.

FIG. 12 is an exploded view of the female safety connectors shown in FIG. 4, where conductor wires are shown installed into the female safety connectors, according to an embodiment of the present disclosure.

FIG. 13 is a perspective view of the male safety connectors mated to the female safety connectors, according to an embodiment of the present disclosure.

FIG. 14 is a perspective view of the male safety connectors and the female safety connectors being mated to an electrical component, according to an embodiment of the present disclosure.

FIG. 15 is a perspective view of male safety connectors in both a first pole and second pole configuration, where the two male safety connectors may be mated to each other, according to an alternative embodiment of the present disclosure.

FIG. 16 is a perspective view of female safety connectors in both a first pole and second pole configuration, where the two female safety connectors may be mated to each other, according to an alternative embodiment of the present disclosure.

FIG. 17 is a cross-sectional view into an exemplary male safety connector, according to an embodiment of the present disclosure.

FIG. 18 is a side view of an exemplary terminal assembly configured to be installed inside the male safety connector, according to an embodiment of the present disclosure.

FIG. 19 is a cross-sectional view of the male safety connector shown in FIG. 17, further including the terminal assembly installed within the male safety connector, according to an embodiment of the present disclosure.

FIG. 20 is an exemplary system diagram describing a first exemplary solar panel system, according to an embodiment of the present disclosure.

FIG. 21 is an exemplary system diagram describing a second exemplary solar panel system, according to an embodiment of the present disclosure.

FIG. 22 is an exemplary system diagram describing a third exemplary solar panel system, according to an embodiment of the present disclosure.

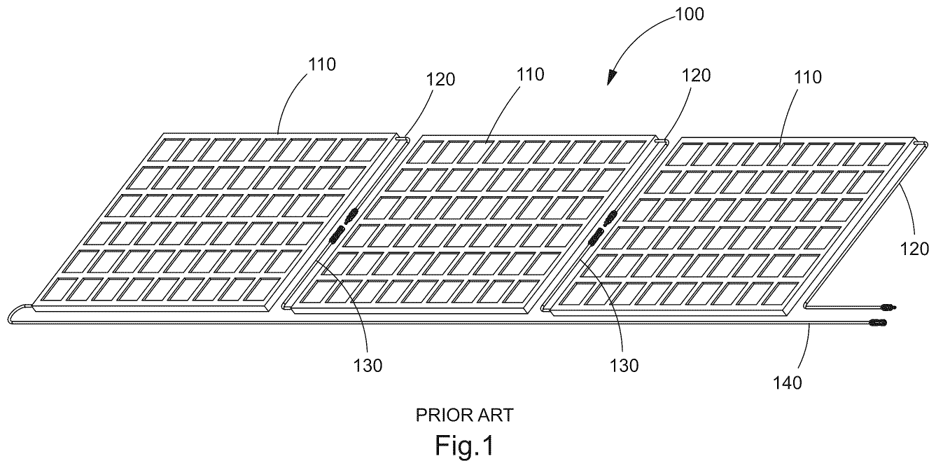

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Disclosed herein is a 2-pole keyed safety connector that is designed to reduce the chance of incorrect connections. The safety connector is configured to achieve these safety features by utilizing both male and female mating features, as well as uniquely shaped keyed connector pairs to distinguish between a first pole embodiment and a second pole embodiment, which together enable connections between the intended designated mating pair safety connectors. So, this design is engineered to prevent unintentional wiring connections from being made. The shape of each keyed connection ensures that the positive and negative wires can only ever be connected to their corresponding mating pieces, which reduces the risk of unintended series connections.

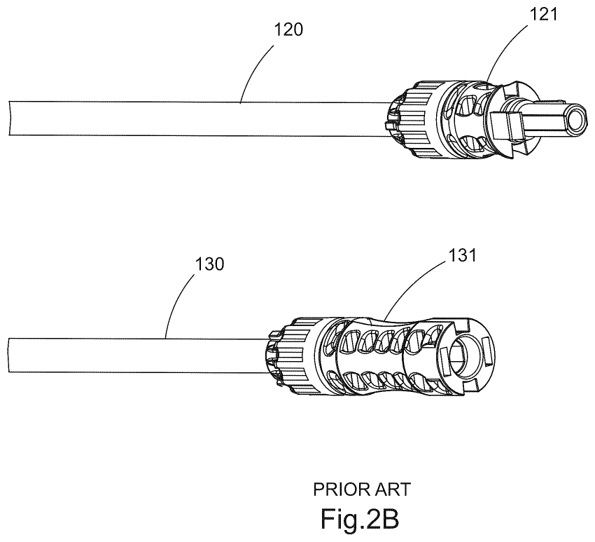

FIG. 3 shows a mating pair of male safety connectors 200, according to an embodiment of this disclosure. The mating pair of male safety connectors 200 may also be referred to as plugs (i.e., mating pair of plugs 200). The mating pair of plugs 200 includes a first pole plug 210 and a second pole plug 220. For exemplary purposes, the first pole may reference a positive electric pole, while the second pole may reference a negative electric pole according to the description provided herein. Although in different embodiments, the referenced poles may be reversed.

The first pole plug 210 includes a first mating feature 211, and the second pole plug 220 includes a second mating feature 221, where the first mating feature 211 and the second mating feature 221 are configured to engage to mate the first pole plug 210 and the second pole plug 220 together. The first mating feature 211 may be an indentation into a housing of the first pole plug 210, and the second mating feature 221 may be a protrusion coming out from a housing of the second pole plug 220, as shown in FIG. 3.

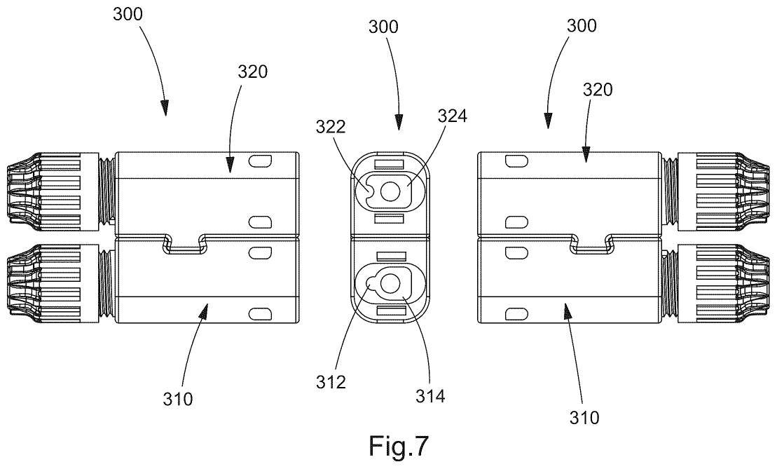

As further shown in FIGS. 8A and 8B, the indentation of the first mating feature 211 may include an alignment protrusion 216, and the protrusion of the second mating feature 221 may include an alignment dimple 226 for receiving the alignment protrusion 216. During a mating of the first pole plug 210 and the second pole plug 220, the protrusion of the second mating feature 221 may slide down into the indentation of the first mating feature 211 until the alignment protrusion 216 fits into the alignment dimple 226.

Referring back to FIG. 3, the first pole plug 210 further includes an end cap 215, a plug protrusion 214, a key-up feature 212 on the plug protrusion 214, and insertion latches 213 on opposites sides of the plug protrusion 214. The key-up feature 212 gives the plug protrusion 214 a unique profile shape so that the first pole plug 210 may be installed into a correspondingly shaped female mating feature in a female safety connector, as will be described in greater detail later in this disclosure. The insertion latches 213 are configured to insert into corresponding openings of a female safety connector, to assist in properly aligning the first pole plug 210 and the corresponding female safety connector when the two are mated together.

Similarly, the second pole plug 220 further includes an end cap 225, a plug protrusion 224, a key-down feature 222 on the plug protrusion 224, and insertion latches 223 on opposites sides of the plug protrusion 224. The key-down feature 222 gives the plug protrusion 224 a unique profile shape so that the second pole plug 220 may be installed into a correspondingly shaped female mating feature in a female safety connector, as will be described in greater detail later in this disclosure. The insertion latches 223 are configured to insert into corresponding openings of a female safety connector, to assist in properly aligning the second pole plug 220 and the corresponding female safety connector when the two are mated together. The first pole plug 210 also includes an O-ring 231 at the base of the insertion plug to provide weatherproofing at the connection point of where the first pole plug 210 is inserted into a receptacle. The second pole plug 220 also includes an O-ring 230 at the base of the insertion plug to provide weatherproofing at the connection point of where the second pole plug 220 is inserted into a receptacle.

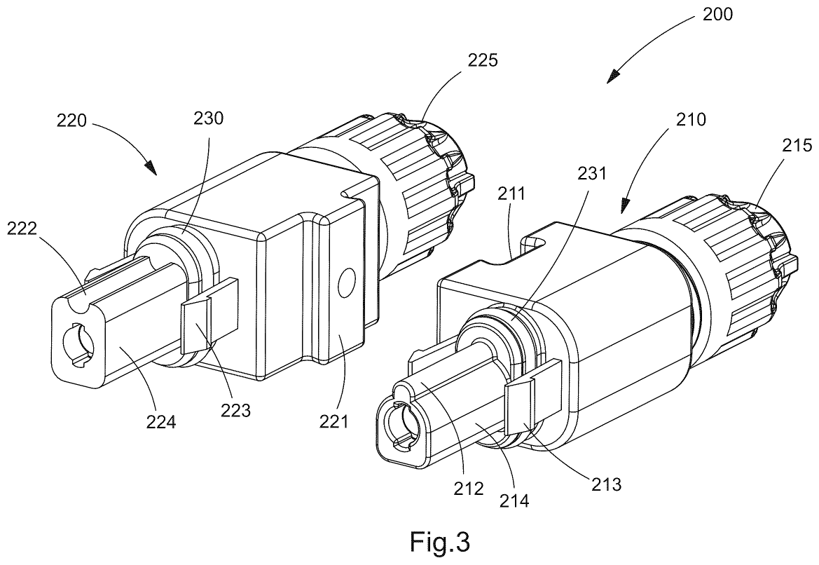

FIG. 4 shows a mating pair of female safety connectors 300, according to an embodiment of this disclosure. The female safety connectors 300 may also be referred to as receptacles (i.e., mating pair of receptacles 300). The mating pair of receptacles 300 includes a first pole receptacle 310 and a second pole receptacle 320. For exemplary purposes, the first pole may reference a positive electric pole, while the second pole may reference a negative electric pole according to the description provided herein. Although in different embodiments, the referenced poles may be reversed.

The first pole receptacle 310 includes a first mating feature 311, and the second pole receptacle 320 includes a second mating feature 321, where the first mating feature 311 and the second mating feature 321 are configured to engage to mate the first pole receptacle 310 and the second pole receptacle 320 together. The first mating feature 311 may be an indentation into a housing of the first pole receptacle 310, and the second mating feature 321 may be a protrusion coming out from a housing of the second pole receptacle 320, as shown in FIG. 4.

As further shown in FIGS. 8C and 8D, the indentation of the first mating feature 311 may include an alignment protrusion 316, and the protrusion of the second mating feature 321 may include an alignment dimple 326 for receiving the alignment protrusion 316. During a mating of the first pole receptacle 310 and the second pole receptacle 320, the protrusion of the second mating feature 321 may slide down into the indentation of the first mating feature 311 until the alignment protrusion 316 fits into the alignment dimple 326.

Referring back to FIG. 4, the first pole receptacle 310 further includes an end cap 315, a plug opening 314, a key-up feature 312 on the plug opening 314, and insertion openings 313 on opposites sides of the plug opening 314. The key-up feature 312 gives the plug opening 314 a unique profile shape so that the plug opening 314 may receive the correspondingly shaped plug protrusion 214 including the key-up feature 212 of the first pole plug 210. The insertion openings 313 are configured to receive the correspondingly shaped insertion latches 213 of the first pole plug 210 to assist in properly aligning the first pole plug 210 and the first pole receptacle 310 when the two are mated together.

Similarly, the second pole receptacle 320 further includes an end cap 325, a plug opening 324, a key-down feature 322 on the plug opening 324, and insertion openings 323 on opposites sides of the plug openings 324. The key-down feature 322 gives the plug opening 324 a unique profile shape so that the plug opening 324 may receive the correspondingly shaped plug protrusion 224 including the key-down feature 222 of the second pole plug 220. The insertion openings 323 are configured to receive the correspondingly shaped insertion latches 223 of the second pole plug 220 to assist in properly aligning the second pole plug 220 and the second pole receptacle 320 when the two are mated together.

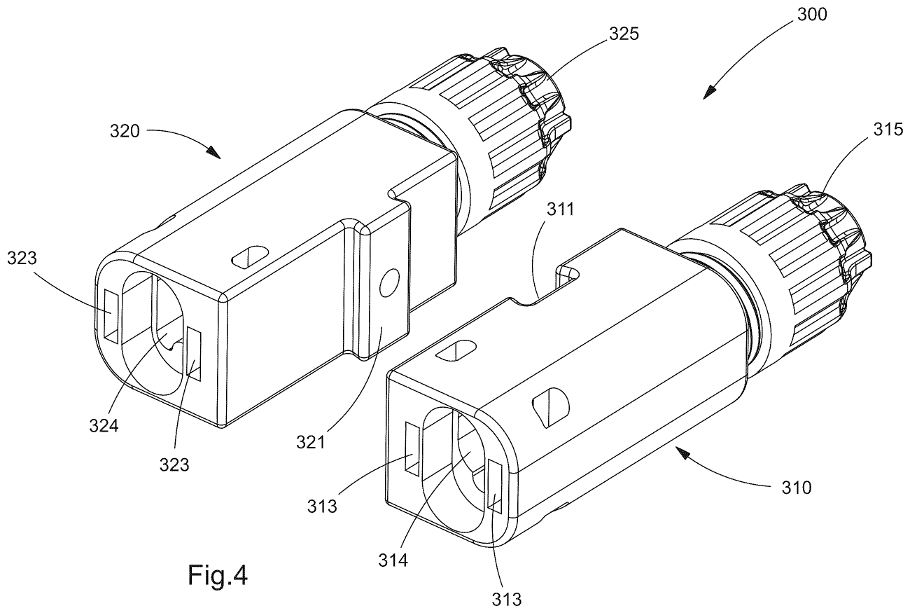

FIG. 5 shows the mating pair of plugs 200 and the mating pair of receptacles 300 in a pre-mating state where the mating pair of plugs 200 and the mating pair of receptacles 300 are aligned for mating together. In this pre-mating state, the first pole plug 210 and the second pole plug 220 are mated together, and the first pole receptacle 310 and the second pole receptacle 320 are mated together. In this pre-mating state, it is shown how the key-up feature 212 of the plug protrusion 214 is shaped to insert into the key-up feature 312 of the plug opening 314, and the key-down feature 222 of the plug protrusion 224 is shaped to insert into the key-down feature 322 of the plug opening 324.

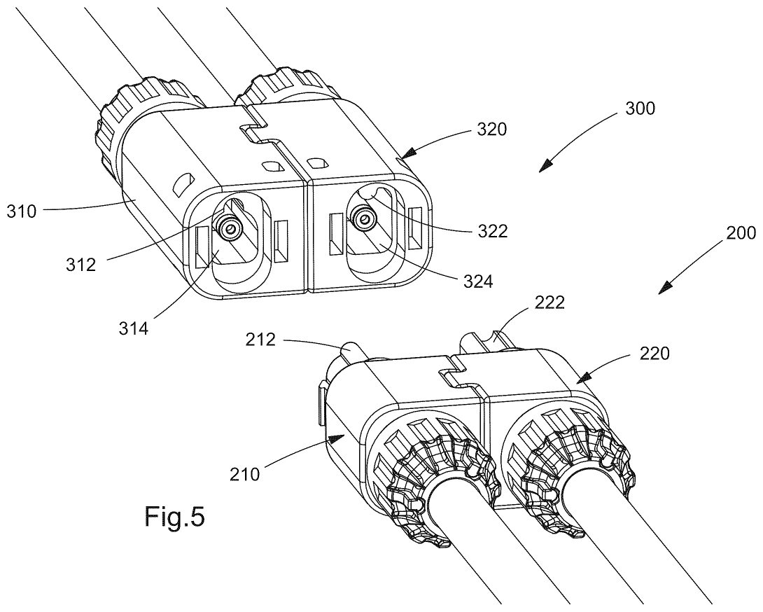

FIG. 6 provides a number of different views of the mating pair of plugs 200. Namely, FIG. 6 provides a top-side view of the mating pair of plugs 200, a side-view of the mating pair of plugs 200, and a bottom-side view of the mating pair of plugs 200.

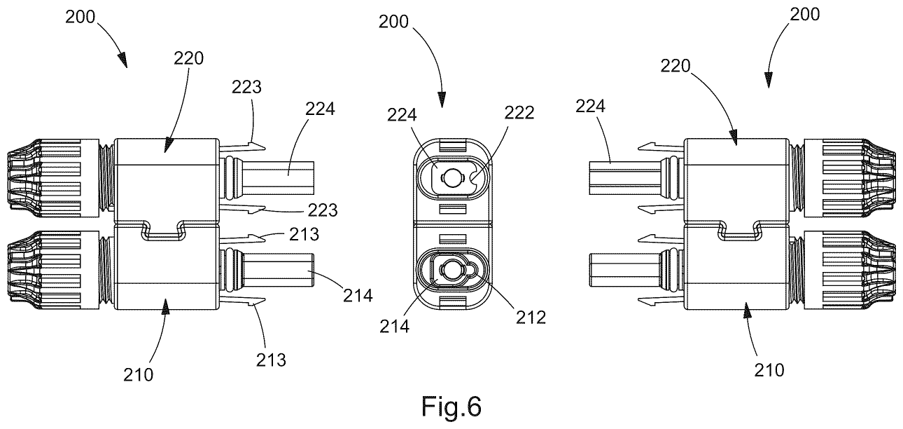

FIG. 7 provides a number of different views of the mating pair of receptacles 300. Namely, FIG. 7 provides a top-side view of the mating pair of receptacles 300, a side-view of the mating pair of receptacles 300, and a bottom-side view of the mating pair of receptacles 300.

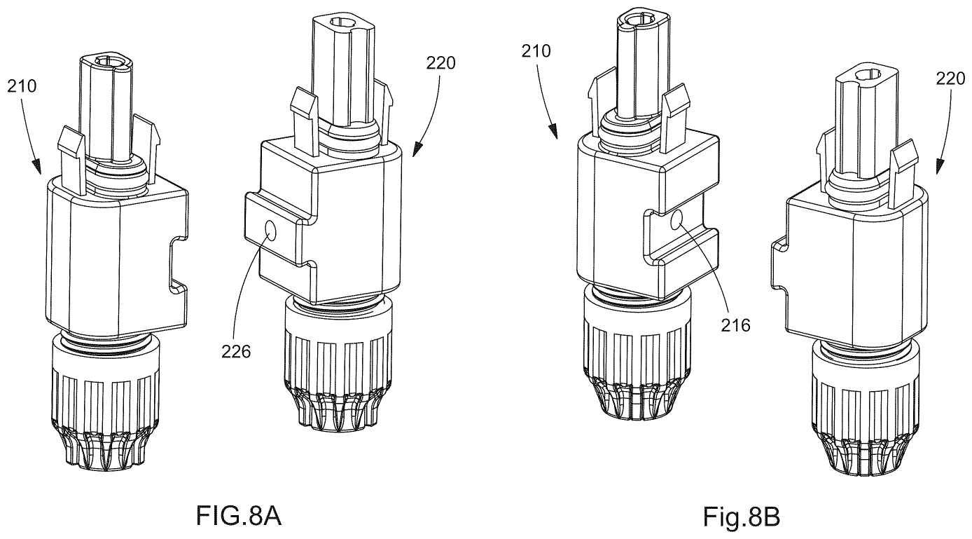

FIG. 9 shows an exploded view of the first pole plug 210 and the second pole plug 220 that are included in the mating pair of plugs 200. This exploded view provides insight into a number of internal components. For example, the first pole plug 210 is shown to include a housing 250 including an end post 219, where the end post 219 includes threads and an end opening 251. The first pole plug 210 also includes a terminal pin 218 and a compression sleeve 217, where the compression sleeve 217 is configured to fit over the end opening 251 so that when the end cap 215 is threaded onto the end post 219, the compression sleeve 217 forms a moisture prevention seal against the end opening 251 to prevent moisture from entering into an internal cavity of the housing 250 when a wire conductor 10 is installed.

Similarly, the second pole plug 220 is shown to include a housing 260 including an end channel 229, where the end channel 229 includes threads and an end opening 261. The second pole plug 220 also includes a terminal pin 228 and a compression sleeve 227, where the compression sleeve 227 is configured to fit over the end opening 261 so that when the end cap 225 is threaded onto the end channel 229, the compression sleeve 227 forms a moisture prevention seal against the end opening 261 to prevent moisture from entering into an internal cavity of the housing 260 when a wire conductor 20 is installed.

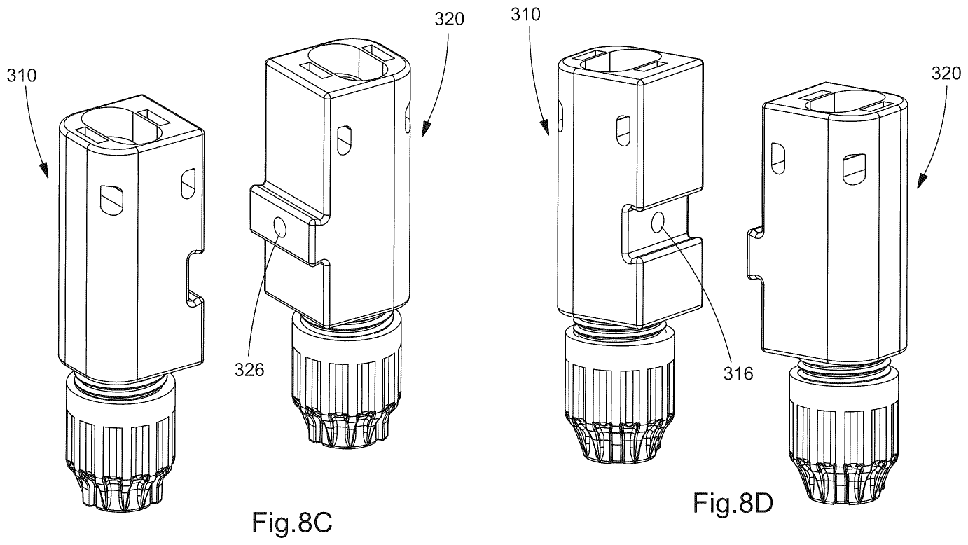

FIG. 10 shows an exploded view of the first pole plug 210 and the second pole plug 220 that are included in the mating pair of plugs 200, and further showing the wire conductor 10 and wire conductor 20 installed. The wire conductor 10 includes an outer layer insulator jacket, and an internal conductor 11 inside the insulator jacket. Similarly, the wire conductor 20 includes an outer layer insulator jacket, and a conductor 21 inside the insulator jacket.

During an installation process, the wire conductor 10 is fit through a center opening of the end cap 215 and a center opening of the compression sleeve 217, as shown in FIG. 10. Then the insulator jacket is removed to expose the conductor 11 from an end portion of the wire conductor 10 that has been inserted through the end cap 215 and the compression sleeve 217. A portion of the exposed conductor 11 is fit into the terminal pin 218, and the terminal pin 218 is crimped to hold the conductor 11 within the terminal pin 218. The terminal pin 218 having the conductor 11 held inside is then pushed into the internal cavity of the housing 250. The end cap 215 is then fastened onto the end post 219 via twisting onto the threads of the end post 219, thus creating a seal with the compression sleeve 217 being compressed against the end opening 251 as the end cap 215 is screwed tightly onto the end post 219.

Similarly, during an installation process the wire conductor 20 is fit through a center opening of the end cap 225 and a center opening of the compression sleeve 227, as shown in FIG. 10. Then the insulator jacket is removed from an end portion of the wire conductor 20 that has been inserted through the end cap 225 and the compression sleeve 227 to expose the conductor 21. A portion of the exposed conductor 21 is fit into the terminal pin 228, and the terminal pin 228 is crimped to hold the conductor 21 within the terminal pin 228. The terminal pin 228 having the conductor 21 held inside is then pushed into the internal cavity of the housing 260. The end cap 225 is then fastened onto the end channel 229 via twisting onto the threads of the end channel 229, thus creating a seal with the compression sleeve 227 being compressed against the end opening 261 as the end cap 225 is screwed tightly onto the end channel 229. As a final installation step, the first pole plug 210 and the second pole plug 220 may be mated together as shown in FIG. 6.

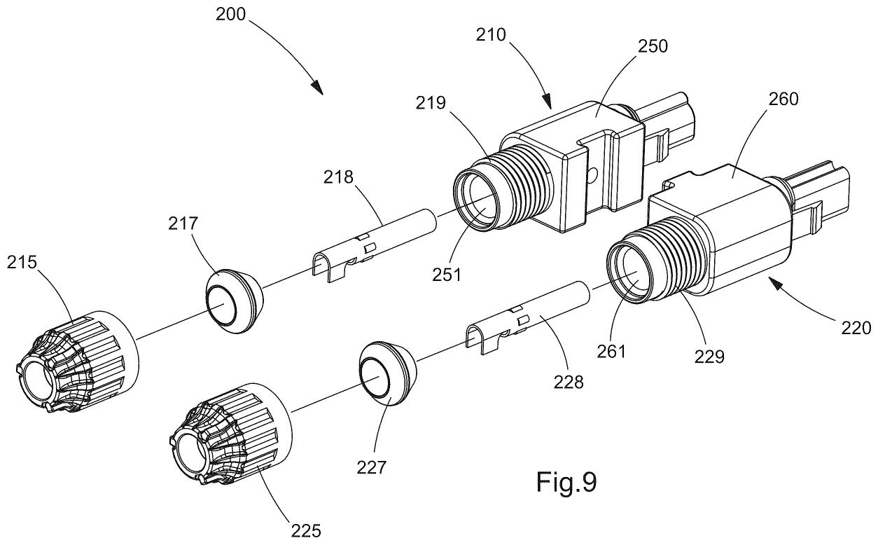

FIG. 11 shows an exploded view of the first pole receptacle 310 and the second pole receptacle 320 that are included in the mating pair of receptacles 300. This exploded view provides insight into a number of internal components. For example, the first pole receptacle 310 is shown to include a housing 350 including an end post 319, where the end post 319 includes threads and an end opening 351. The first pole receptacle 310 also includes a terminal pin 318 and a compression sleeve 317, where the compression sleeve 317 is configured to fit over the end opening 351 so that when the end cap 315 is threaded onto the end post 319, the compression sleeve 317 forms a moisture prevention seal against the end opening 351 to prevent moisture from entering into an internal cavity of the housing 350 when a wire conductor 30 is installed.

Similarly, the second pole receptacle 320 is shown to include a housing 360 including an end channel 329, where the end channel 329 includes threads and an end opening 361. The second pole receptacle 320 also includes a terminal pin 328 and a compression sleeve 327, where the compression sleeve 327 is configured to fit over the end opening 361 so that when the end cap 325 is threaded onto the end channel 329, the compression sleeve 327 forms a moisture prevention seal against the end opening 361 to prevent moisture from entering into an internal cavity of the housing 360 when a wire conductor 40 is installed.

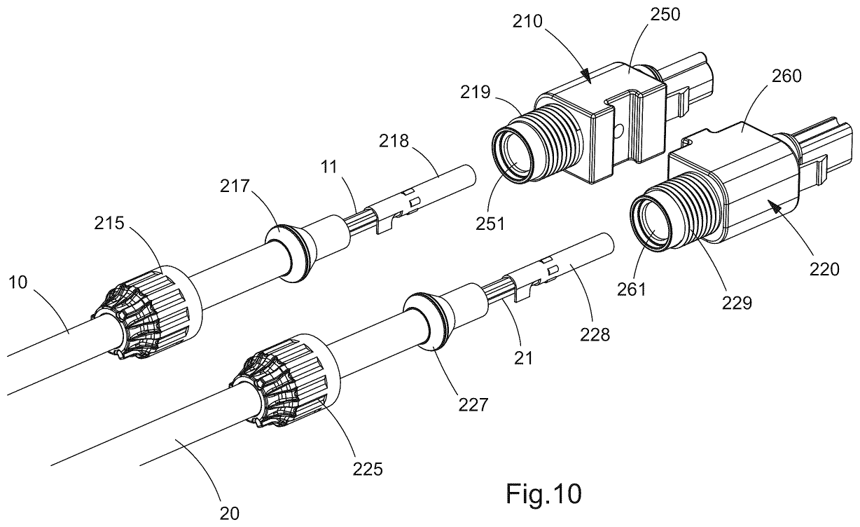

FIG. 12 shows an exploded view of the first pole receptacle 310 and the second pole receptacle 320 that are included in the mating pair of receptacles 300, and further showing the wire conductor 30 and wire conductor 40 installed. The wire conductor 30 includes an outer layer insulator jacket, and a conductor 31 inside the insulator jacket. Similarly, the wire conductor 40 includes an outer layer insulator jacket, and a conductor 41 inside the insulator jacket.

During an installation process, the wire conductor 30 is fit through a center opening of the end cap 315 and a center opening of the compression sleeve 317, as shown in FIG. 12. Then the insulator jacket is removed to expose the conductor 31 from an end portion of the wire conductor 30 that has been inserted through the end cap 315 and the compression sleeve 317. A portion of the exposed conductor 31 is fit into the terminal pin 318, and the terminal pin 318 is crimped to hold the conductor 31 within the terminal pin 318. The terminal pin 318 having the conductor 31 held inside is then pushed into the internal cavity of the housing 350. The end cap 315 is then fastened onto the end post 319 via twisting onto the threads of the end post 319, thus creating a seal with the compression sleeve 317 being compressed against the end opening 351 as the end cap 315 is screwed tightly onto the end post 319.

Similarly, during an installation process the wire conductor 40 is fit through a center opening of the end cap 325 and a center opening of the compression sleeve 327, as shown in FIG. 12. Then the insulator jacket is removed to expose the conductor 41 from an end portion of the wire conductor 40 that has been inserted through the end cap 325 and the compression sleeve 327. A portion of the exposed conductor 41 is fit into the terminal pin 328, and the terminal pin 328 is crimped to hold the conductor 41 within the terminal pin 328. The terminal pin 328 having the conductor 41 held inside is then pushed into the internal cavity of the housing 360. The end cap 325 is then fastened onto the end channel 329 via twisting onto the threads of the end channel 329, thus creating a seal with the compression sleeve 327 being compressed against the end opening 361 as the end cap 325 is screwed tightly onto the end channel 329. As a final installation step, the first pole receptacle 310 and the second pole receptacle 320 may be mated together as shown in FIG. 7.

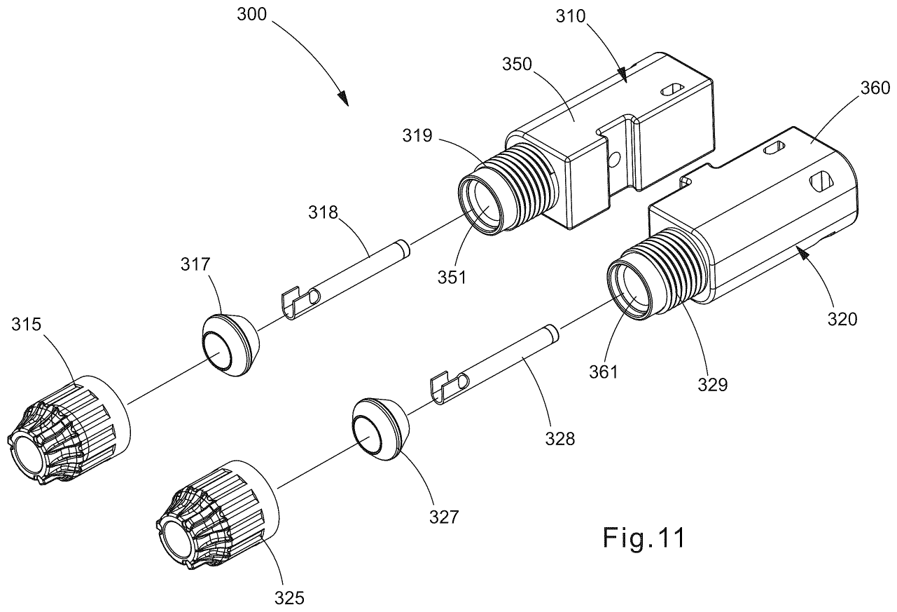

FIG. 13 shows a perspective view of the mating pair of plugs 200 and the mating pair of receptacles 300 in an installed state with wire conductors 10, 20, 30, 40, and mated together according to the proper polarity, according to an embodiment.

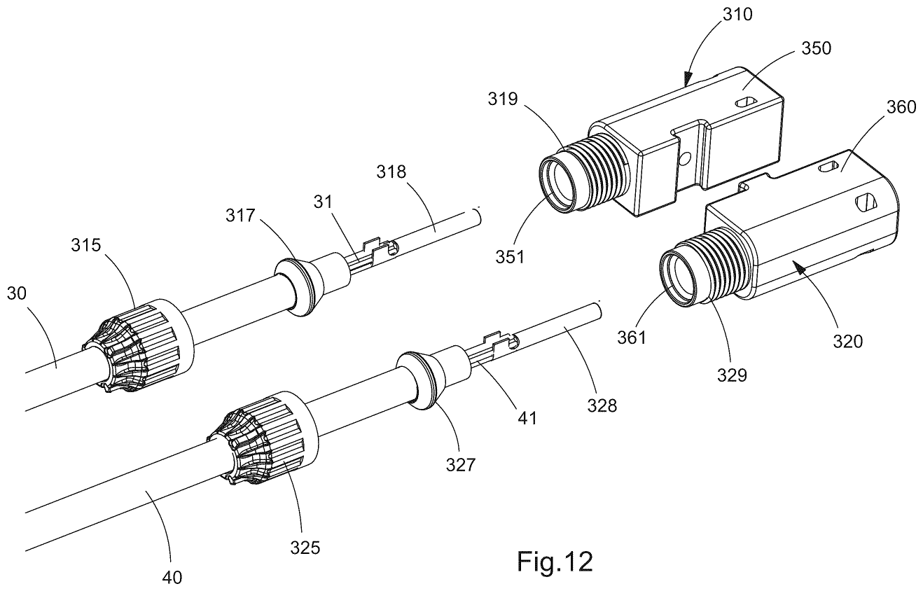

FIG. 14 shows a perspective view of an insulation piercing connector 400 including a first pole receptacle 410 for receiving the first pole plug 210, and a second pole receptacle 420 for receiving the second pole plug 220, according to an alternative embodiment. It follows that the polarity keyed design for the first pole receptacle 310, second pole receptacle 320, first pole plug 210, and second pole plug 220 may be incorporated into other components found within the solar panel system to ensure proper polarity mating.

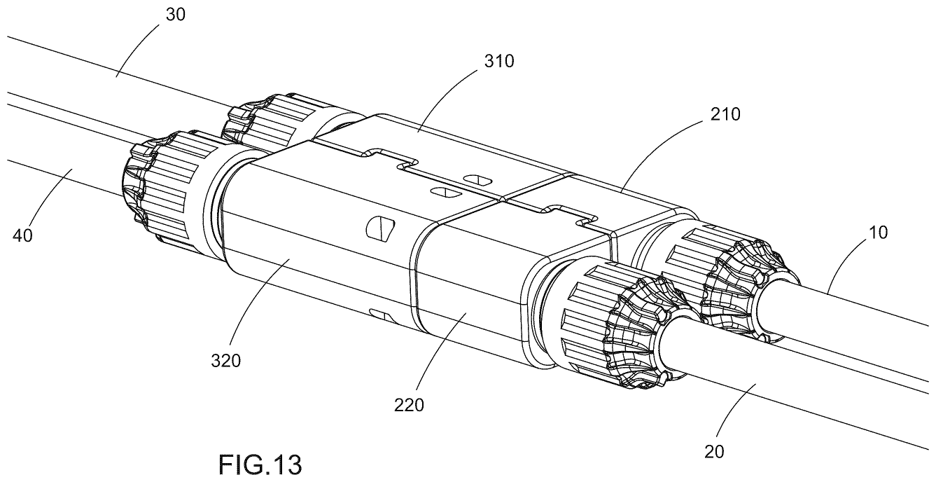

FIG. 15 shows a mating pair of male safety connectors 600, according to an alternative embodiment of this disclosure. The mating pair of male safety connectors 600 may also be referred to as plugs (i.e., mating pair of plugs 600) and can be seen to be substantially the same configuration as the male safety connectors 200 described previously. For example, the mating pair of plugs 600 includes a first pole plug 610 and a second pole plug 620. For exemplary purposes, the first pole may reference a positive electric pole, while the second pole may reference a negative electric pole according to the description provided herein. Although in different embodiments, the referenced poles may be reversed.

The first pole plug 610 includes a first mating feature 611, and the second pole plug 620 includes a second mating feature 621, where the first mating feature 611 and the second mating feature 621 are configured to engage to mate the first pole plug 610 and the second pole plug 620 together. The first mating feature 611 may be an indentation into a housing of the first pole plug 610, and the second mating feature 621 may be a protrusion coming out from a housing of the second pole plug 620, as shown in FIG. 15.

Also shown in FIG. 15, the first pole plug 610 further includes an end cap 615, a plug protrusion 614, two key-up features 612 on the plug protrusion 614, and insertion latches 613 on opposites sides of the plug protrusion 614. Having two key-up features 612 on opposite sides of the plug protrusion 614, as opposed to the single key-up feature 212 in the first pole plug 210, is a unique feature of the first pole plug 610. Having the two key-up features 612 on opposite sides of the plug protrusion 614 may provide for more efficient molding of the first pole plug 610 as it provides a symmetrical design, compared to having only a single key-up feature 212 as on the first pole plug 210.

The key-up feature 612 gives the plug protrusion 614 a unique profile shape so that the first pole plug 610 may be installed into a correspondingly shaped female mating feature in a female safety connector, as will be described in greater detail later in this disclosure. The insertion latches 613 are configured to insert into corresponding openings of a female safety connector, to assist in properly aligning the first pole plug 610 and the corresponding female safety connector when the two are mated together.

Similarly, the second pole plug 620 further includes an end cap 625, a plug protrusion 624, two key-down features 622 on the plug protrusion 624, and insertion latches 623 on opposites sides of the plug protrusion 624. Having the two key-down features 622 on opposite sides of the plug protrusion 624 may provide for more efficient molding of the second pole plug 620 as it provides a symmetrical design, compared to having only a single key-down feature 222 as on the second pole plug 220.

The two key-down features 622 gives the plug protrusion 624 a unique profile shape so that the second pole plug 620 may be installed into a correspondingly shaped female mating feature in a female safety connector, as will be described in greater detail later in this disclosure. The insertion latches 623 are configured to insert into corresponding openings of a female safety connector, to assist in properly aligning the second pole plug 620 and the corresponding female safety connector when the two are mated together.

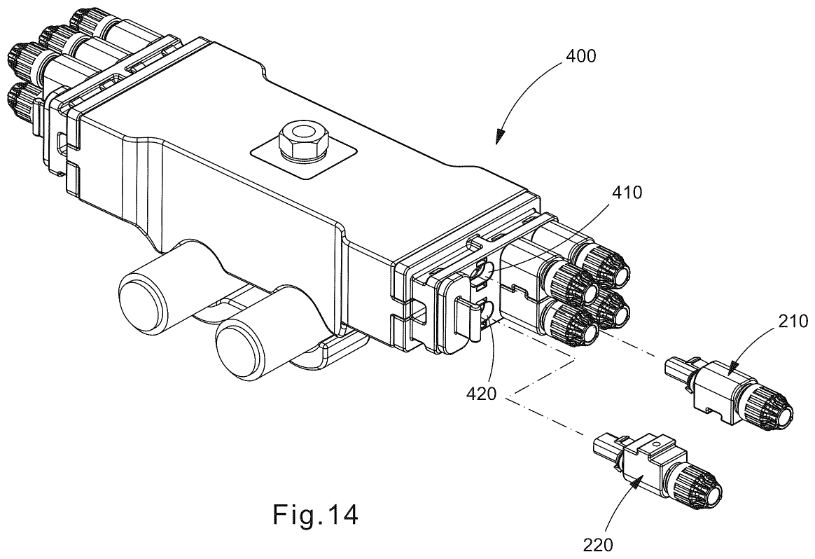

FIG. 16 shows a mating pair of female safety connectors 700, according to an alternative embodiment of this disclosure. The female safety connectors 700 may also be referred to as receptacles (i.e., mating pair of receptacles 700). The mating pair of receptacles 700 includes a first pole receptacle 710 and a second pole receptacle 720. For exemplary purposes, the first pole may reference a positive electric pole, while the second pole may reference a negative electric pole according to the description provided herein. Although in different embodiments, the referenced poles may be reversed.

The first pole receptacle 710 includes a first mating feature 711, and the second pole receptacle 720 includes a second mating feature 721, where the first mating feature 711 and the second mating feature 721 are configured to engage to mate the first pole receptacle 710 and the second pole receptacle 720 together. The first mating feature 711 may be an indentation into a housing of the first pole receptacle 710, and the second mating feature 721 may be a protrusion coming out from a housing of the second pole receptacle 720, as shown in FIG. 16.

As also shown in FIG. 16, the first pole receptacle 310 further includes an end cap 715, a plug opening 714, two key-up features 712 on the plug opening 714, and insertion openings 713 on opposites sides of the plug opening 714. The two key-up feature 712 gives the plug opening 714 a unique profile shape so that the plug opening 714 may receive the correspondingly shaped plug protrusion 614 including the two key-up features 612 of the first pole plug 610. The insertion openings 713 are configured to receive the correspondingly shaped insertion latches 613 of the first pole plug 610 to assist in properly aligning the first pole plug 610 and the first pole receptacle 710 when the two are mated together.

Similarly, the second pole receptacle 720 further includes an end cap 725, a plug opening 724, two key-down features 722 on the plug opening 724, and insertion openings 723 on opposites sides of the plug openings 724. The two key-down feature 722 give the plug opening 724 a unique profile shape so that the plug opening 724 may receive the correspondingly shaped plug protrusion 624 including the two key-down features 622 of the second pole plug 620. The insertion openings 723 are configured to receive the correspondingly shaped insertion latches 623 of the second pole plug 620 to assist in properly aligning the second pole plug 620 and the second pole receptacle 720 when the two are mated together.

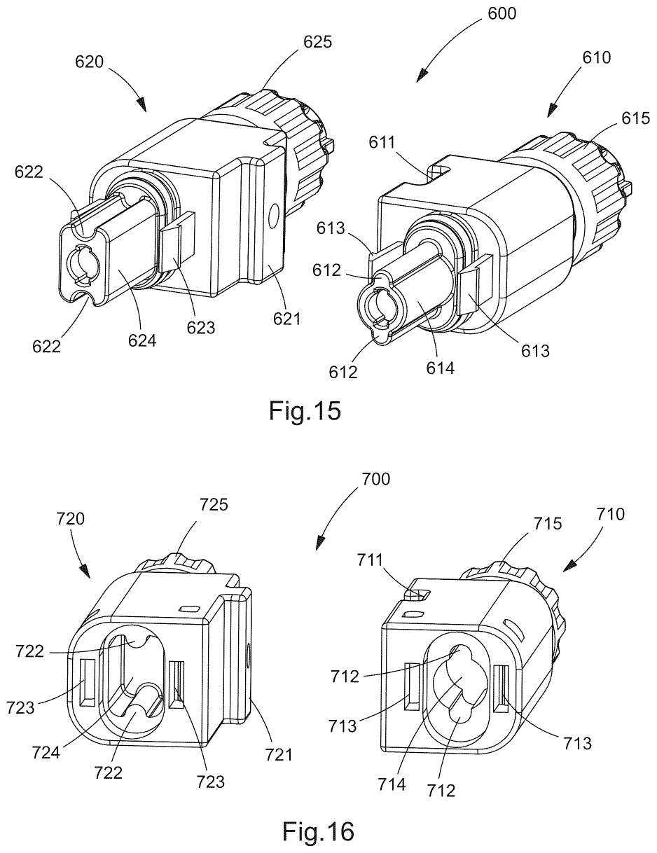

FIG. 17 shows a cross-sectional view of an exemplary male-type plug 800 such as, for example, the first pole plug 210, 610 or the second pole plug 220, 620, according to an embodiment of the present disclosure. The plug 800 includes a housing body 810, an end post 819 including threading, a pair of insertion latches 813, an end opening 851 that opens up to a first internal housing 820, a plug extension 814, a second internal housing 830 formed inside the plug extension 814, a plug extension opening 861, and a key-up feature 812.

Inside the housing body 810, an internal curved wall 821 is formed inside the first internal housing 820, and one or more snap-fit arms 811 (e.g., three snap-fit arms 811 are included in the plug 800) are formed at an end of the second internal housing 830. Each of the snap-fit arms may include a latch head 811a. The internal curved wall 821 and the snap-fit arms 811 are all formed as a single piece with the plug 800 during a molding process for the plug 800. This provides a much more efficient design that is more cost effective and/or faster to make without the need for complex tooling that would be needed for more traditional plug designs.

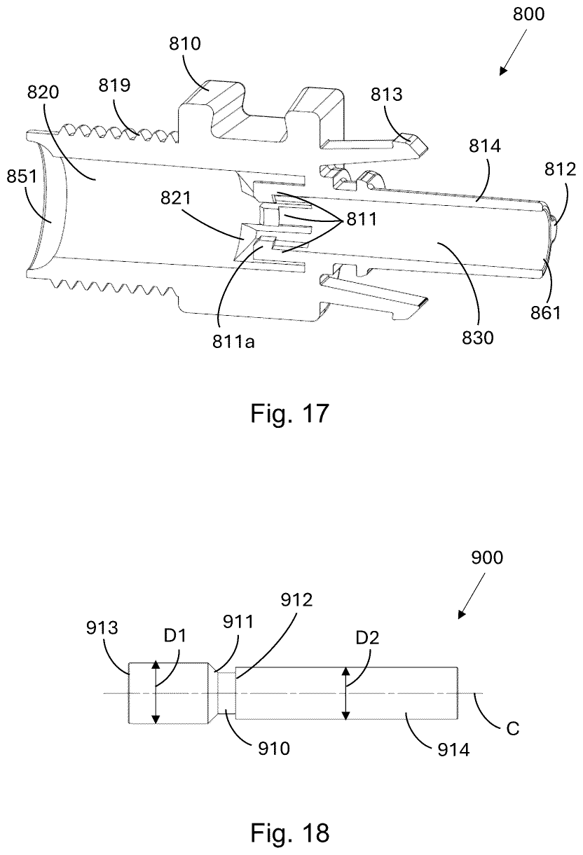

FIG. 18 shows a side view of a terminal assembly 900 that is configured to be installed inside the first internal housing 820 and the second internal housing 830 of the plug 800. The terminal assembly 900 includes a tail end 913 and a front section 914, where an undercut 910 is created between the tail end 913 and the front section 914. The undercut 910 is made to include a ramped edge 911 on one side, and a flat edge 912 on an opposite side. The terminal assembly 900 is made from an electrically conductive material such as, for example, copper or copper-based alloy, and so the undercut 910 may be made from a machined process for shaving the undercut 910 from the terminal assembly 900. The terminal assembly 900 may be cylindrical in shape, and so a diameter D1 of the tail end 913 may be larger than a diameter D2 of the front section 914. FIG. 18 is also illustrated to show a center-line C going through the terminal assembly 900.

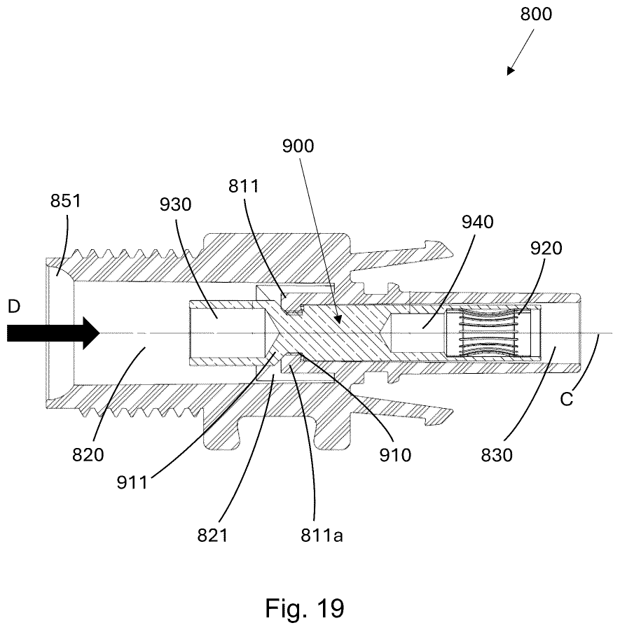

FIG. 19 is a cross-sectional side view of the plug 800 having the terminal assembly 900 installed inside the first internal housing 820 and the second internal housing 830. To install the terminal assembly 900, the terminal assembly 900 is inserted first through the end opening 851 to enter into the first internal housing 820 in the installation direction D. The front section 914 continues to move in the installation direction D to enter into the second internal housing 830 until the latch heads 811a come down and fit inside the undercut 910 of the terminal assembly 900 to complete the installed state of the terminal assembly 900 inside the plug 800. Once in this installed state, the flat edge 912 abutting against the latch heads 811a prevents the terminal assembly 900 from retreating backwards, and the ramped edge 911 abutting against the curved wall 821 prevents the terminal assembly 900 from moving further in the installation direction D. In this way, the interaction between the latch heads 811a and the undercut 910 provide a simple and effective locking mechanism that ensures the terminal assembly 900 remains in the installed state.

FIG. 19 additionally shows a cross-sectional view of the terminal assembly that shows it to have a first internal housing 930 that may be bored into the tail end 913, and a second internal housing 940 that may be bored into the front section 914. The second internal housing 940 is configured to hold a grabbing cage 920 that is configured to include a center tunnel for receiving a conductor pin, where the grabbing cage 920 flexes to receive and then hold onto the conductor pin.

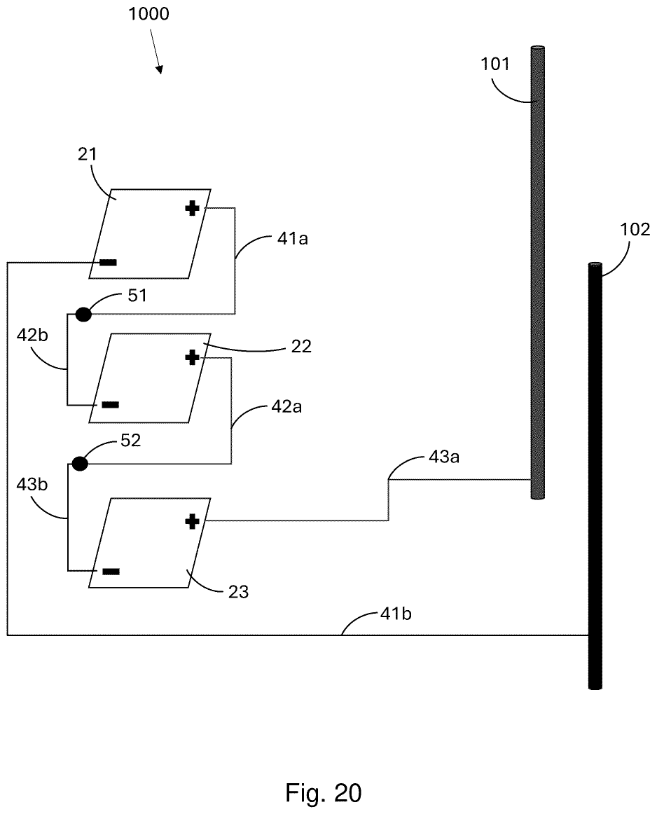

FIG. 20 shows an exemplary first solar panel system 1000 that may utilize one or more of the poled plug or receptacles described herein, according to an embodiment of this disclosure. At a high level, a first solar panel 21, a second solar panel 22, and a third solar panel 23 are installed into a field to gather solar energy. Each of these solar panels 21, 22, 23 include both a positive terminal and negative terminal. In this first solar panel system, the first solar panel 21, the second solar panel 22, and the third solar panel 23 are connected in series to transmit/receive power signals to/from the positive poled main-run wire 101 and a negative poled main-run wire 102 via cable strings 41a, 42a, 43a, 41b, 42b, 43b. The cable strings 41a, 42a, 43a, 41b, 42b, 43b coming out of the solar panels 21, 22, 23 are likely a smaller gauge cable conductor (i.e., smaller diameter) when compared to the larger gauge cable conductor (i.e., larger diameter) of the main-run cable 101, 102.

To connect the first solar panel 21 and the second solar panel 22 in series, a cable string 41a coupled to a positive terminal of the first solar panel 21 is terminated with a positive pole plug (e.g., second pole plug 220) and a cable string 42b coupled to a negative terminal of the second solar panel 22 is terminated with a positive pole receptacle (e.g., second pole receptacle 320). Then the positive pole plug is mated with the positive pole receptacle at a first coupling point 51.

To connect the second solar panel 22 and the third solar panel 23 in series, a cable string 42a coupled to a positive terminal of the second solar panel 22 is terminated with a positive pole plug (e.g., second pole plug 220) and a cable string 43b coupled to a negative terminal of the third solar panel 23 is terminated with a positive pole receptacle (e.g., second pole receptacle 320). Then the positive pole plug is mated with the positive pole receptacle at a second coupling point 52.

The final positive terminal in the third solar panel 23 is connected to a cable string 43a that is eventually coupled to the positive pole main-run 101. The cable string 41b is coupled to the negative terminal in the first solar panel 21 and serves to return a power signal from the negative poled main-run wire 102. In this way, the first solar panel system 1000 connects the solar panels 21, 22, 23 in series while only using a single type of plug (e.g., second pole plug 220) and a single type of receptacle (e.g., second pole receptacle 320), which makes this installation simpler and less prone to installation mistakes that would mistakenly install plugs and receptacles having incorrect poles.

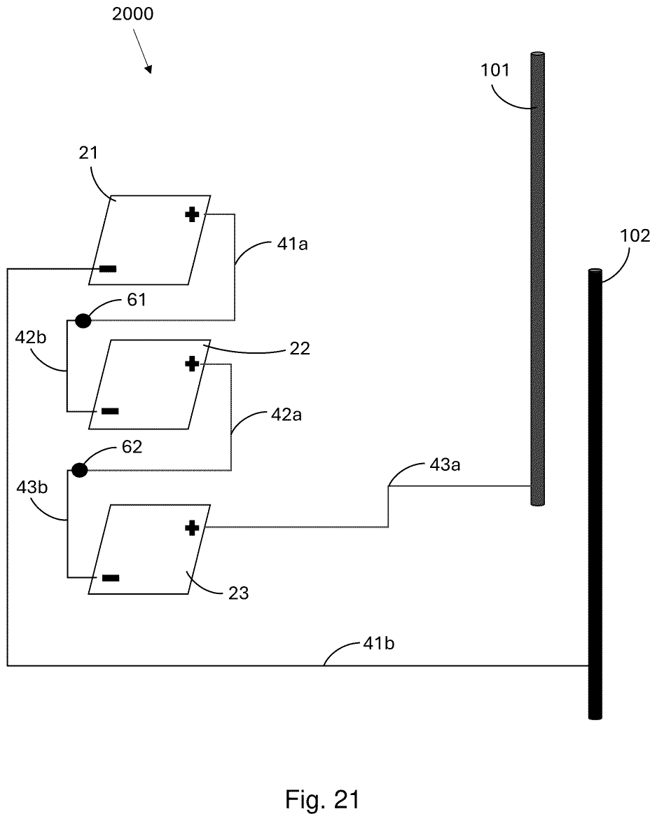

FIG. 21 shows an exemplary second solar panel system 2000 that may utilize one or more of the poled plug or receptacles described herein, according to an embodiment of this disclosure. This second solar panel system 2000 is configured essentially the same as the first solar panel system 1000. The only difference with the second solar panel system 2000 is the type of connectors used at the first coupling point 61 and the second coupling point 62, compared to the first coupling point 51 and the second coupling point 52 in the first solar panel system 1000.

In the second solar panel system 2000 the type of connectors may alternate for each subsequent coupling point 61, 62. For example, the cable string 41a may be terminated with a positive pole plug (e.g., second pole plug 220), and the cable string 42b may be terminated with a positive pole receptacle (e.g., second pole receptacle 320), so that these two positive connectors may mate at the first coupling point 61. But then the cable string 42a may be terminated with a negative pole plug (e.g., first pole plug 210) and the cable string 43b may be terminated a negative pole receptacle (e.g., first pole receptacle 310), so that these two negative pole connectors may be mate at the second coupling point 61. While this type of alternating pole connections between the solar panels 21, 22, 23 in the second solar panel system 2000 is possible, it adds an additional level of complexity that may not be desirable as it increases the risk of installation error.

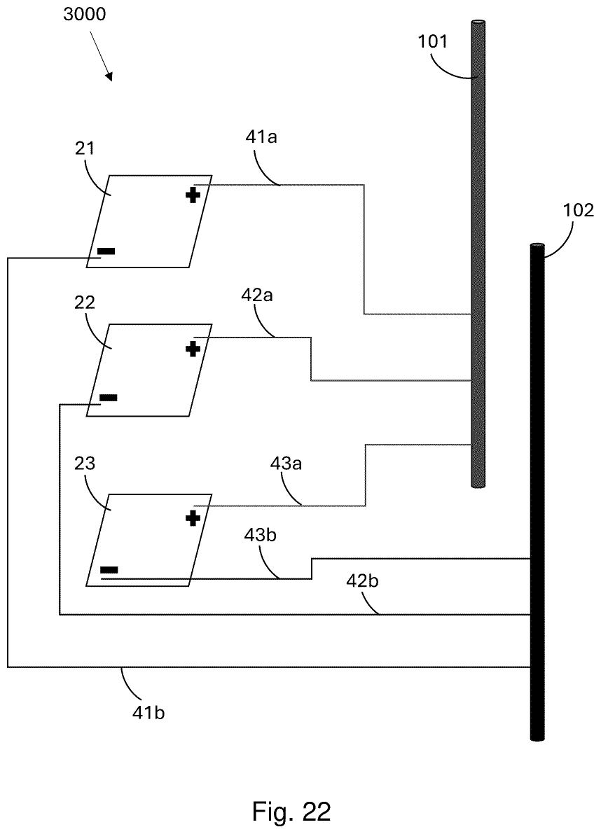

FIG. 22 shows an exemplary third solar panel system 3000 that may utilize one or more of the poled plug or receptacles described herein, according to an embodiment of this disclosure. In this third solar panel system 3000, the solar panels 21, 22, 23 are connected in parallel with respect to the positive main-run cable 101 and the negative main-run cable 102.

Cable strings 41a, 42a, 43a are coupled to the positive terminals of the solar panels 21, 22, 23 and are configured to be coupled to the positive main-run cable 101. Cable strings 41b, 42b, 43b are coupled to the negative terminals of the solar panels 31, 32, 33 and are configured to be coupled to the negative main-run cable 102.

Because it may not be practical, or safe, to pierce the insulation of the main-run cables 101, 102 in each instance of the cable strings 41a, 42a, 43a, 41b, 42b, 43b, a single insulation piercing connector (IPC) device may tap into both main-run cables 101, 102. Then only a male-type plug (e.g., first pole plug 210 and/or second pole plug 220) may be terminated at the ends of the cable strings 41a, 42a, 43a, 41b, 42b, 43b to be mated to the IPC device tapped into the main run cables 101, 102. For example, the cable strings 41a, 42a, 43a may be terminated with the positive pole plugs (e.g., second pole plug 220) and the cable strings 41b, 42b, 43b may be terminated with the negative pole plugs (e.g., first pole plug 210).

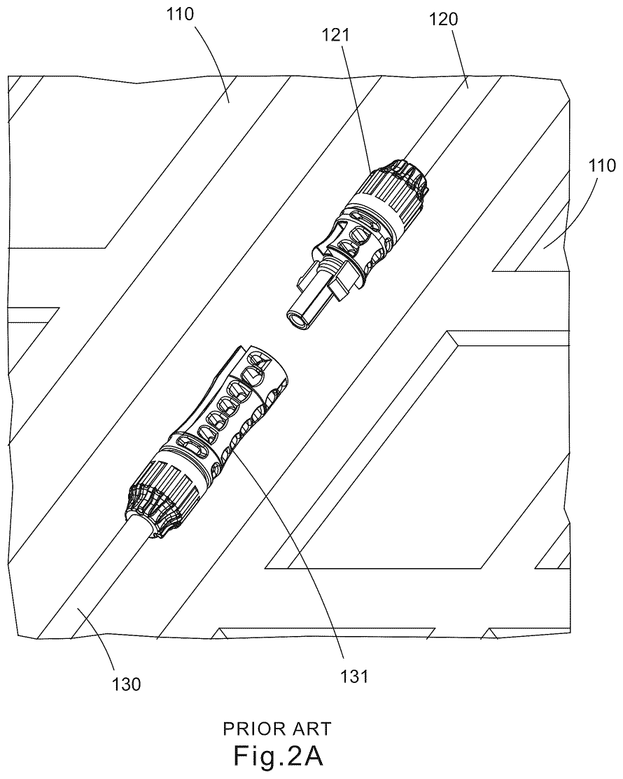

In other embodiments the polarity of the plugs and/or receptacles may be reversed from the description provided herein. Although this disclosure describes distinguishing the 2-poles of a plug or receptacle using either a single key-up or key-down feature, other shapes outside the simple circular profiles provided in the connectors and receptacles shown in FIG. 2B are within the scope of the present disclosure. For example, profile shapes that are different for a positive pole and negative pole plug and receptacle are within the scope of this disclosure.

The present disclosure thus describes a 2-pole keyed safety connector as described above. As is readily apparent from the foregoing, various non-limiting embodiments of the systems, devices, and methods have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A connector system comprising:
a first connector comprising:
a first body;
a first plug positioned at a first end of the first body, the first plug including a first keyed feature;
a first mating feature included in the first body;
a first end post positioned at a second end of the first body, the first end post including threads; and
a first end cap configured to screw onto the threads of the first end post;
a second connector comprising:
a second body;
a second plug positioned at a first end of the second body, the second plug including a second keyed feature;
a second mating feature included in the second body, wherein the second mating feature is configured to mate with the first mating feature of the first connector;
a second end post positioned at a second end of the second body, the second end post including threads; and
a second end cap configured to screw onto the threads of the second end post.

2. The connector system of claim 1,
the first connector further comprising:
at least one alignment latch positioned next to the first plug; and
the second connector further comprising:
at least one alignment latch positioned next to the second plug.

3. The connector system of claim 1,
the first connector further comprising:
a first compression sleeve positioned between the first end cap and the first end post, the first compression sleeve configured to seal an opening of the first end post when the first end cap is screwed onto the threads of the first end post; and
a first terminal pin configured to hold a conductor from a first wire conductor installed through the first end cap and the first compression sleeve;
the second connector further comprising:
a second compression sleeve positioned between the second end cap and the second end post, the second compression sleeve configured to seal an opening of the second end post when the second end cap is screwed onto the threads of the second end post; and
a second terminal pin configured to hold a conductor from a second wire conductor installed through the second end cap and the second compression sleeve.

4. The connector system of claim 1, the first mating feature further comprising a dimple; and
the second mating feature further comprising an alignment protrusion configured to fit into the dimple when the second mating feature is mated to the first mating feature.

5. The connector system of claim 1, further comprising:
a third connector comprising:
a third body;
a first receptacle positioned at a first end of the third body, the first receptacle including a key-up feature and configured to receive the first plug of the first connector;
a third mating feature configured into the third body;
a third end post positioned at a second end of the third body, the third end post including threads; and
a third end cap configured to screw onto the threads of the third end post;
a fourth connector comprising:
a fourth body;
a second receptacle positioned at a first end of the fourth body, the second receptacle including a key-down feature and configured to receive the second plug of the second connector;
a fourth mating feature protruding out the fourth body, wherein the fourth mating feature is configured to fit into the third mating feature to mate the fourth connector to the third connector;
a fourth end post positioned at a second end of the fourth body, the fourth end post including threads; and
a fourth end cap configured to screw onto the threads of the fourth end post.

6. The connector system of claim 5,
the third connector further comprising:
at least one alignment opening positioned next to the first receptacle, the at least one alignment opening configured to receive at least one latch of the first connector; and
the fourth connector further comprising:
at least one alignment opening positioned next to the second receptacle, the at least one alignment opening configured to receive at least one latch of the second connector.

7. The connector system of claim 5,
the third connector further comprising:
a third compression sleeve positioned between the third end cap and the third end post, the third compression sleeve configured to seal an opening of the third end post when the third end cap is screwed onto the threads of the third end post; and
a third terminal pin configured to hold a conductor from a third wire conductor installed through the third end cap and the third compression sleeve;
the fourth connector further comprising:
a fourth compression sleeve positioned between the fourth end cap and the fourth end post, the fourth compression sleeve configured to seal an opening of the fourth end post when the fourth end cap is screwed onto the threads of the fourth end post; and
a fourth terminal pin configured to hold a conductor from a fourth wire conductor installed through the fourth end cap and the fourth compression sleeve.

8. The connector system of claim 5, the third mating feature further comprising a dimple; and
the fourth mating feature further comprising an alignment protrusion configured to fit into the dimple when the fourth mating feature is mated to the third mating feature.

9. The connector system of claim 1, the first connector further comprising:
an inner housing formed inside the first body, the inner housing comprising a latch arm including a latch head and a curved wall; and
a terminal assembly comprising an undercut, a flat edge, and a ramped edge, wherein when the terminal assembly is installed inside the inner housing the latch head is configured to rest inside the undercut with the ramped edge configured to abut against the curved wall to restrict the terminal assembly from being removed from the inner housing.

10. A connector system comprising:
a plug connector comprising:
a plug housing body;
a plug protrusion positioned at a first end of the plug connector, the plug protrusion including a first keyed feature;
a first end post positioned at a second end of the plug housing body, the first end post including threads; and
a first end cap configured to screw onto the threads of the first end post;
a receptacle connector comprising:
a receptacle body;
a receptacle opening positioned at a first end of the receptacle body, the receptacle opening including a second keyed feature configured to allow the plug protrusion to fit inside the receptacle opening;
a second end post positioned at a second end of the receptacle body, the second end post including threads; and
a second end cap configured to screw onto the threads of the second end post.

11. The connector system of claim 10,
the plug connector further comprising:
at least one alignment latch positioned next to the plug protrusion; and
the receptacle connector further comprising:
at least one alignment opening positioned next to the receptacle opening, the alignment opening configured to allow the alignment latch to fit inside the alignment opening.

12. The connector system of claim 10,
the plug connector further comprising:
a first compression sleeve positioned between the first end cap and the first end post, the first compression sleeve configured to seal an opening of the first end post when the first end cap is screwed onto the threads of the first end post; and
the receptacle connector further comprising:
a second compression sleeve positioned between the second end cap and the second end post, the second compression sleeve configured to seal an opening of the second end post when the second end cap is screwed onto the threads of the second end post.

13. The connector system of claim 10, the plug connector further comprising a first mating feature configured to mate with a second mating feature included on a secondary plug connector; and
the receptacle connector further comprising a third mating feature configured to mate with a fourth mating feature included on a secondary receptacle connector.

14. The connector system of claim 13, wherein the first mating feature includes a dimple and the second mating feature includes an alignment protrusion, and the third mating feature includes a dimple and the fourth mating feature includes an alignment protrusion.

15. The connector system of claim 10, the plug connector further comprising:
an inner housing formed inside the plug housing body, the inner housing comprising a latch arm including a latch head and a curved wall; and
a terminal assembly comprising an undercut, a flat edge, and a ramped edge, wherein when the terminal assembly is installed inside the inner housing the latch head is configured to rest inside the undercut with the ramped edge configured to abut against the curved wall to restrict the terminal assembly from being removed from the inner housing.
